(19) United States
(12) Patent Application Publication
(10) Pub. No.: US 2003/0196086 A1
(43) Pub. Date: Oct. 16, 2003

(54) Information processing apparatus, information processing system, information processing method, storage medium and program

(75) Inventors: Tomochika Murakami, Kanagawa (JP); Satoru Wakao, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/391,565

(22) Filed: Mar. 20, 2003

(30) Foreign Application Priority Data
Apr. 12, 2002 (JP) 2002-111035

(51) Int. Cl. H04L 9/00

(52) U.S. Cl. 713/161; 713/176

(57) ABSTRACT

An object is that even if a transmitting end delivers data without adding signature data thereto, a receiving end can verify the originality of the data. The transmitting end registers the signature data of the data on an external data managing device on a network together with identification information for uniquely identifying the data. The receiving end requests and acquires the signature data of the data together with the identification information extracted from the data, from the external data managing device on the network. The receiving end can check the originality of the data using the signature data acquired from the external data managing device on the network.

### BACKGROUND OF THE INVENTION

1. Field of the Invention

The present invention relates to an information processing apparatus, an information processing system, an information processing method, a computer-readable storage medium storing a program to implement the method, and the program, for detecting falsification of digital data that represents, for example, images, pictures and sound.

2. Description of the Related Art

Recently, images and pictures picked up by a camera or the like, or sound recorded by a recording device have been digitalized, and stored as digital data on a hard disk, an external storage medium or the like.

Information processing apparatuses including personal computers can display or reproduce such digital data. Such digital data is then delivered via a communication line such as the Internet.

It has been considered to make use of such digital data, for example, in insurance companies where evidential pictures are dealt with in handling the aftermath of accidents, or in construction companies where pictures are used to make a record of the progress at building sites.

However, the remarkable progress of data processing technique has made it possible to easily edit or falsify digital data by using a photo retouching tool or editing tool, thus posing a problem that the digital data has low originality and is lacking the ability as evidence.

Therefore, an apparatus or a system is proposed which detects that digital data is edited or falsified (these are hereinafter together referred to as “falsification”).

More specifically, for example, the above apparatus or system is configured to perform predetermined calculation on the basis of at least either secret information peculiar to a picture input device or secret information peculiar to an external device connected to the picture input device, and on the basis of digital data of a picked-up picture obtained by the picture input device, in order to produce information for identifying the digital data, that is, digital signature data, so that the digital signature data and the digital data of the picked-up picture obtained by the picture input device will be an output of the picture input device.

The above apparatus or system uses hash functions and public key encryption to generate the digital signature data.

The above apparatus or system, as described below, generates digital signature data using the hash functions and public key encryption at a transmitting end, and checks the originality of this digital signature data at a receiving end.

First, the transmitting end compresses plaintext data M by means of the hash function with a secret key as “Ks” and a public key as “Kp”, and performs calculation processing for calculating an output h of a certain length.

Next, the transmitting end converts the output h by means of the secret key “Ks”, and performs the calculation processing for generating its resultant as digital signature data s, which follows an equation:

D(Ks, h)=s

The transmitting end then transmits the digital signature data s and plaintext data M.

On the other hand, the receiving end performs the calculation processing that follows an equation:

E(Kp, s)=E(Kp, D(Ks, h″))=h″

for converting the digital signature data s transmitted from the transmitting end by means of the public key Kp, so as to obtain h″. The receiving end also performs the calculation processing for compressing plaintext data M′ transmitted from the transmitting end by means of the same hash function as that used at the transmitting end and thus calculating h′. If h′ and h″, which are the results of the calculation processing, correspond, the plaintext data M′ is judged that is has the originality.

If the plaintext data M is falsified during transmission and receiving, the plaintext data M′ is judged that is does not have the originality since K(Kp, s)=E(Kp, D(Ks, h″))=h″ and h′ which is the plaintext data M′ compressed by means of the same hash function as that used at the transmitting end do not correspond.

It should be noted that the hash function is unidirectional, so that even if the digital signature data s is falsified in accordance with the falsification of the plaintext data M, it is not impossible to detect the falsification of the plaintext data M′ because the plaintext data M needs to be obtained from the output h.

Furthermore, the hash function is the function used to speed up the generation of the digital signature data described above, and has a function of outputting data h of a certain length by applying processing to the plaintext data M of an optional length. This output data h is referred to as a hash value of the plaintext data M (or a message digest, or a digital fingerprint).

Qualities required for the hash function include a quality which requires unidirectionality and collision resistance.

The unidirectionality is a quality in which when the data h is given, it is difficult to calculate the plaintext data M that satisfies “h=H(M)” in the form of calculated amount.

The collision resistance is a quality in which when the plaintext data M is given, it is difficult to calculate the plaintext data M′ (M≠M′) that satisfies “H(M)=H(M′)” in the form of calculated amount, and it is difficult to calculate the plaintext data M, M′ that satisfy “H(M)=H(M′) as well as M≠M′” in the form of calculated amount.

Known hash functions include, for example, MD-2, MD-4, MD-5, SHA-1, RIPEMD-128 or RIPEMD-160, and these algorithms are available to the public.

On the other hand, a public key cryptosystem is a cryptosystem in which an encryption key and a decryption key are different; the encryption key is open to the public and the decryption key is kept in secret. Characteristics of such a public key cryptosystem include the following characteristics (a) to (c), for example.

(a) The encryption key and decryption key are different, and the encryption key can be open to the public, so that it is not necessary to deliver the encryption key in secret and is easy to deliver the key.

(b) The encryption key for each user is open to the public, so that each user may simply memorize only his own decryption key in secret.

(c) Such an authentication function can be achieved that the receiving end can check if the transmitting end of a message (plaintext data M) is a false person or not and if the message is falsified or not.

To be concrete, if, with respect to the plaintext data M, the encryption operation using a public encryption key (public key) Kp is expressed as “E(Kp, M)” and the decryption operation using a secret decryption key (secret key) Ks is expressed as “D(Ks, M)”, for example, the public key encryption algorithm will first satisfy the following two conditions (1) and (2).

(1) When the public key Kp is given, it is easy to calculate E(Kp, M), and when the secret key Ks is given, it is easy to calculate D(Ks, M).

(2) If the secret key Ks is not known, it is difficult to decide the plaintext data M in terms of the calculated amount even if the computational procedure of the public key Kp and E(Kp, M), and C=E(Kp, M) are known.

Furthermore, the above public key encryption algorithm can achieve a secret communication by satisfying the following condition (3) in addition to the conditions (1) and (2).

(3) With respect to all the plaintext data Ms, E(Kp, M) can be defined, and D(Ks, E(Kp, M))=M is satisfied. That is, since the public key p is open to the public, anybody can calculate E(Kp, M), but only the user himself who has the secret key Ks can calculate D(Ks, E(Kp, M)) to obtain the plaintext data M.

Furthermore, the above public key encryption algorithm can achieve an authenticated communication by satisfying the following condition (4) in addition to the conditions (1) and (2).

(4) With respect to all the plaintext data Ms, D(Ks, M) can be defined, and E(Kp, D(Ks, M))=M is satisfied. That is, only the user himself who has the secret key Ks can calculate D(Ks, M), so that even if other users calculate D(Ks′, M) using a false secret key Ks′ and pretend to be the user who has the secret key Ks, the receiving end can find out that the received data is unauthorized from E(Kp, D(Ks′, M))≠M. Further, if D(Ks, M) is falsified, the receiving end can find out that the received data is unauthorized from E(Kp, D(Ks, M)′)≠M.

Cryptosystems that can perform the above secret communication and authenticated communication typically include, for example, RSA encryption, R encryption or W encryption.

For example, encryption and decryption based on the RSA cryptosystem, which are used most at present, are expressed by the following equations.

Encryption conversion using an encryption key (e, n) is expressed by an equation:

C=M^{e}(mod n)

and, the conversion for decrypting this with a decryption key (d, n) is expressed by an equation:

M=C^{d}(mod n)

Moreover,

n=p·q

where p and q are each large different prime numbers.

As described above, in a conventional manner, the transmitting end generates digital signature data using the hash function and public key cryptosystem for the digital data to be targeted (target digital data), and transmits the digital signature data added to the target digital data. On the other hand, the receiving end compares the hash value calculated during verification with the hash value obtained from the digital signature data by use of the digital signature data added to the received digital data, thereby judging the originality of the data. If, then, even one bit is modified in the target digital data (if even one bit is modified in the plaintext data M), the received target digital data is judged that it does not have the originality.

Therefore, by generating digital signature data using the hash function and public key cryptosystem for the target digital data and by adding this to the target digital data, it is possible to prove the originality of the target digital data such as images, music, documents or moving images and detect falsification thereof.

However, the conventional apparatus or system described above does not allow adding the digital signature data to the target digital data when the target digital data is the data in a file format that does not provide a proper position for adding the digital signature data.

Furthermore, even if the target digital data is the data in a file format capable of adding the digital signature data, for example, in the case where the target digital data is image data, the digital signature data added to the image data may be lost when the target digital data is converted into an image format using image editing software. Such a problem is thus posed that the originality can not be verified despite the fact that the image context has not been changed.

### SUMMARY OF THE INVENTION

The present invention has thus been attained to eliminate the above disadvantages, and is intended to provide an information processing apparatus, an information processing system and an information processing method, a computer-readable storage medium storing a program to implement the method, and the program, which are capable of verifying the originality of digital data without adding digital signature data for the digital data to the digital data.

Other features and advantageous of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of a digital signature generating apparatus to which the present invention is applied;

FIG. 2 is a block diagram showing the configuration of a digital signature verifying apparatus to which the present invention is applied;

FIG. 3 is a diagram for illustrating a conventional digital signature;

FIG. 4 is a block diagram showing the configuration of a digital signature data generating apparatus of an ID reference network storing type to which the above digital signature generating apparatus is applied;

FIGS. 5A, 5B and 5C are diagrams for describing one example of digital data (image data) to be processed by the above digital signature generating apparatus;

FIG. 6 is a diagram for describing a network system having the functions of the above digital signature generating apparatus and the above digital signature verifying apparatus;

FIG. 7 is a diagram for describing one example of reference listing data retained by a watermark ID managing server of the above network system;

FIG. 8 is a diagram for describing constitution to obtain digital signature data of a terminal device of the above network system;

FIG. 9 is a diagram for describing another example of the above reference listing data;

FIG. 10 is a block diagram showing the configuration of a computer that reads from a computer-readable storage medium and executes a program for the computer to accomplish the functions of the above digital signature generating apparatus and the above digital signature verifying apparatus; and

FIG. 11 is a diagram for describing a network system having the functions of the above digital signature generating apparatus and the above digital signature verifying apparatus.

### DESCRIPTION OF THE PREFERRED EMBODIMENTS

Embodiments of the present invention will hereinafter be described using the drawings.

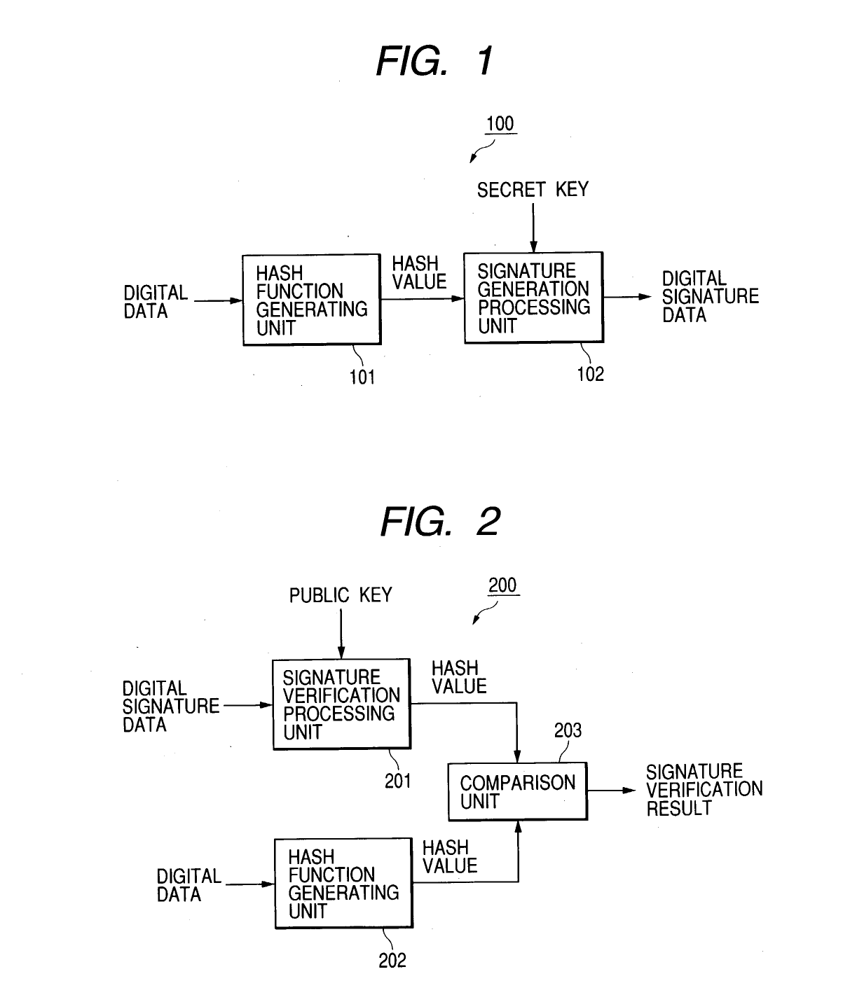

The present invention is applied, for example, to a digital signature generating apparatus 100 as shown in FIG. 1 and to a digital signature verifying apparatus 200 as shown in FIG. 2.

In the present embodiment, the digital signature generating apparatus 100 (transmitting end) generates digital signature data for target digital data by means of a hash function and public key encryption. It then transmits the target digital data to the digital signature verifying apparatus 200 which is its receiving end. The transmitting end also transmits the digital signature data to a server on a network where the digital signature data is registered. The receiving end verifies a hash value obtained from the target digital data and a hash value obtained from the digital signature data which is obtained from the server, so as to check the originality of the received target digital data.

Furthermore, in the present embodiment, the hash function and public key encryption are used to generate the digital signature data in the digital signature generating apparatus 100.

Hereinafter, the configuration and operation of the digital signature generating apparatus 100 and the digital signature verifying apparatus 200 in the present embodiment will be concretely described, and moreover a device or system to which the digital signature generating apparatus 100 and the digital signature verifying apparatus 200 are applied will be concretely described.

<Configuration and Operation of Digital Signature Generating Apparatus 100>

The digital signature generating apparatus 100 comprises a hash function generating unit 101 and a signature generation processing unit 102, as shown in FIG. 1.

Digital data to be processed (also referred to as target digital data) is input from, for example, a digital camera or a digital video camera to the hash function generating unit 101.

The hash function generating unit 101 calculates a hash value from the target digital data using the hash function, and supplies the signature generation processing unit 102 with the hash value.

The signature generation processing unit 102 generates digital signature data for the target digital data by applying calculation processing to the hash value supplied from the hash function generating unit 101 using a secret key in a public key cryptosystem.

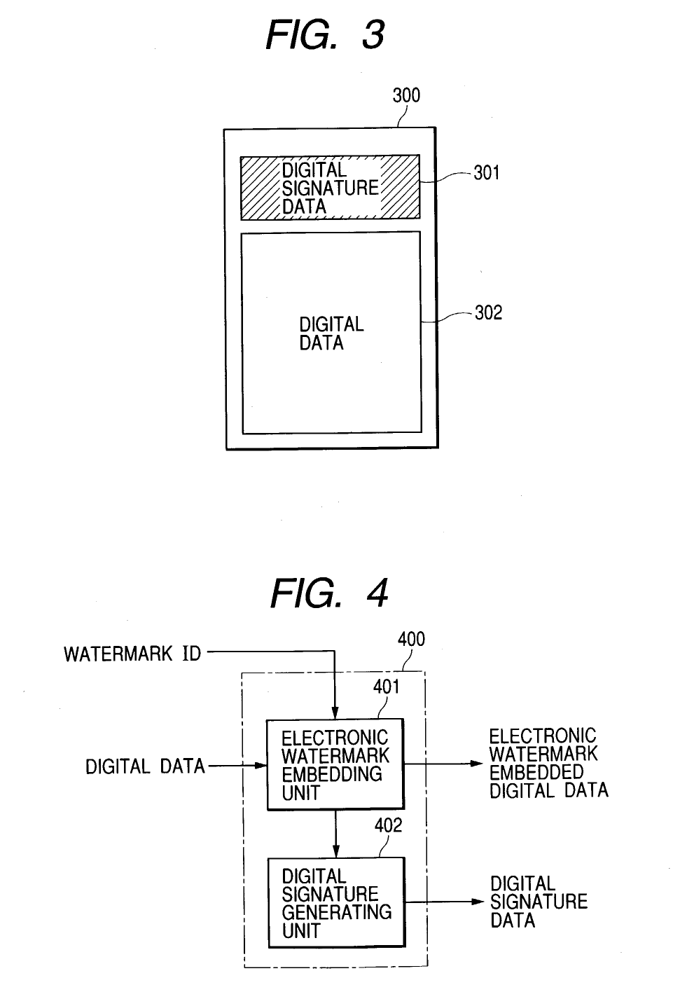

Here, in a conventional configuration, for example, digital signature data 301 is added to a predetermined position of a header or the like in a file 300 that stores target digital data 302 as shown in FIG. 3, so that when no proper position is provided for adding the digital signature data 301 in the file 300, the digital signature data can not be added to the target digital data 302.

On the contrary, in the configuration of the present embodiment, the digital signature data is not added to the target digital data, but, as the detail is described later, the digital signature data is retained by the server connected on a network.

<Configuration and Operation of Digital Signature Verifying Apparatus 200>

The digital signature verifying apparatus 200 comprises a signature verification processing unit 201, a hash function generating unit 202 and a comparison unit 203, as shown in FIG. 2 mentioned above.

Here, in a conventional configuration, the digital signature data 301 added to the target digital data 302 in the file 300 as shown in FIG. 3 mentioned above is taken in, and with this, signature verification is performed.

On the contrary, in the present embodiment, as the detail is described later, the digital signature verifying apparatus 200 obtains the digital signature data for the target digital data from the server connected on a network.

Therefore, in the digital signature verifying apparatus 200, the digital signature data for the target digital data is input to the signature verification processing unit 201 from the server connected on the network.

The signature verification processing unit 201 restores the hash value by applying calculation processing to the digital signature data by means of the public key in the public key cryptosystem, and inputs this to the comparison unit 203 at a subsequent stage.

On the other hand, the hash function generating unit 202 reads the target digital data from a predetermined position of the file in which the target digital data is stored, and calculates a hash value from the target digital data using the hash function, and then inputs this to the comparison unit 203 at a subsequent stage.

The comparison unit 203 compares the hash value from the signature verification processing unit 201 with the hash value from the hash function generating unit 202, and outputs a value (e.g., “1”) representing “true” as a verification result when the two hash values are identical, or on the other hand outputs a value (e.g., “0”) representing “false” as a verification result when the two hash values are not identical.

It should be noted that in the present embodiment, “to generate digital signature data” means to calculate the digital signature data from the target digital data by means of the digital signature generating apparatus 100, as described using FIG. 1 mentioned above, and “to verify digital signature data” means to verify the target digital data that is digitally signed, by means of the digital signature verifying apparatus 200, as described using FIG. 2 mentioned above.

Furthermore, for example, to make it possible to verify the originality of the digital data to which format conversion or the like has been applied, it is desirable to generate digital signature data not for encrypted digital data but for digital data expressed by spatial sample values.

<Application Example of Digital Signature Generating Apparatus 100>

FIG. 4 shows a digital signature data generating apparatus of an ID reference network storing type 400 having the function of the above digital signature generating apparatus 100.

The digital signature data generating apparatus of the ID reference network storing type 400 comprises an electronic watermark embedding unit 401, and a digital signature generating unit 402 having the function of the above digital signature generating apparatus 100, as shown in FIG. 4 mentioned above.

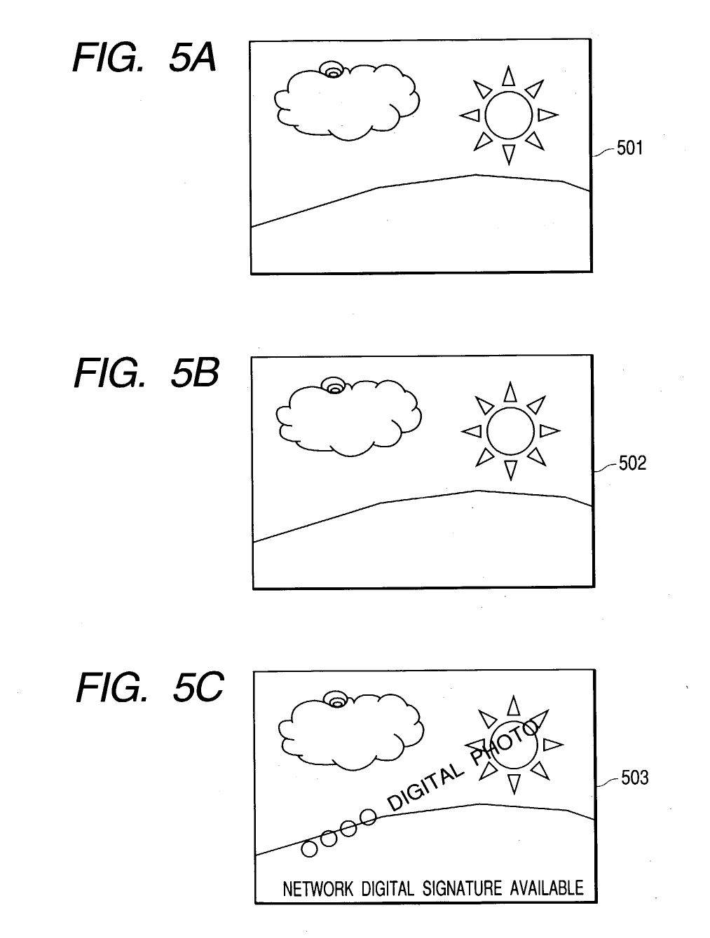

For example, if the target digital data (data for which digital signature data is generated) is image data 501 as shown in FIG. 5A, the image data 501 is input to the electronic watermark embedding unit 401.

The electronic watermark embedding unit 401 embeds a watermark ID in the image data 501 using an electronic watermark technique.

Concretely, first of all, the electronic watermark technique is a technique for changing the target image data in a manner not to be appreciated by humans and not to damage the content of the target image data (here the image data 501) and for embedding secondary information (here, the watermark ID), and a large number of algorithms have been already known.

In the present embodiment, electronic watermark algorithms used by the electronic watermark embedding unit 401 are not limited to specific algorithms, but any optional algorithm is applicable as long as it is capable of changing the digital data in a manner not to be appreciated by humans and not to damage the content of the image data and embedding secondary information.

For example, the electronic watermark embedding unit 401 embeds a watermark ID in the image data 501 shown in FIG. 5A mentioned above, and generates image data 502 as shown in FIG. 5B.

Little difference can be seen between the image data 502, and the image data 501 before the watermark ID is embedded therein, as shown in FIGS. 5A and 5B mentioned above.

Furthermore, for example, the electronic watermark embedding unit 401 embeds visible characters or marks in the image data 501 shown in FIG. 5A mentioned above so as not to damage the content of the image, and generates image data 503 as shown in FIG. 5C. In this case, the visible characters or marks may explicitly indicate to the user of the image data that verifiable digital signature data is available through the network.

As described above, the electronic watermark embedding unit 401 not only generates electronic watermark embedded image data in which the watermark ID is embedded (the image data 502 of FIG. 5B mentioned above, the image data 503 of FIG. 5C, or the like), but also outputs the electronic watermark embedded image data to the digital signature generating unit 402.

The digital signature generating unit 402 generates digital signature data for the electronic watermark embedded image data from the electronic watermark embedding unit 401 using the secret key in the public key cryptosystem by means of the same function as that of the digital signature generating apparatus 100 shown in FIG. 1 mentioned above so as to output the digital signature data.

Therefore, the target digital data and watermark ID are input to the digital signature data generating apparatus of the ID reference network storing type 400, and the electronic watermark embedded image data and digital signature data are output from the digital signature data generating apparatus of the ID reference network storing type 400.

<System to Which Digital Signature Generating Apparatus 100 and Digital Signature Verifying Apparatus 200 are Applied>

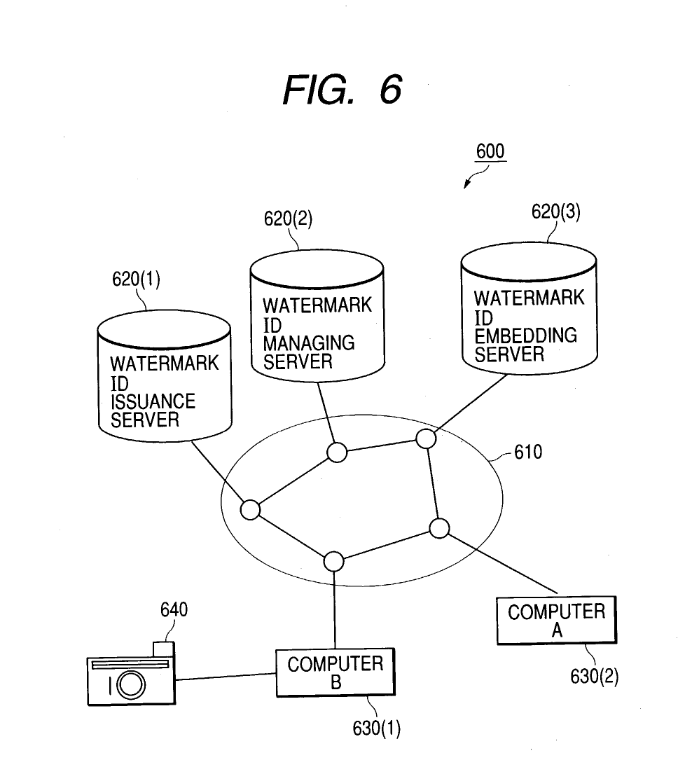

FIG. 6 illustrates a network system 600 that includes devices having the function of the digital signature generating apparatus 100 or the digital signature verifying apparatus 200.

Here, the description is focused on a storage location of the digital signature data and on the verification of the electronic watermark embedded image data using the digital signature data, in the network system 600.

The network system 600 has a configuration in which a plurality of servers 620(1), 620(2), . . . , and a plurality of terminal devices 630(1), 630(2), . . . , are connected so as to be able to communicate on a network 610 such as the Internet.

It should be noted that the three servers 620(1), 620(2) and 620(3), and the two terminal devices 630(1), 630(2) are constituted to be connected on the network 610, for brevity of illustration in FIG. 6 mentioned above, but the number of those connected is not limited to this.

The terminal devices 630(1), 630(2) are each constituted of personal computers.

For example, a digital data input device 640 such as a digital camera for inputting the image data 501 shown in FIG. 5A mentioned above is connected to the terminal device 630(1).

The terminal device 630(1) has, for example, the function of the digital signature generating apparatus 100 shown in FIG. 1 mentioned above, and the terminal device 630(1), details of which will be described later, has, for example, the function of the digital signature verifying apparatus 200 shown in FIG. 2 mentioned above.

The server 620(1) is a watermark ID issuance server, and issues the watermark ID for the image data 501.

The server 620(2) is a watermark ID managing server, and manages and stores data (reference listing data) for corresponding the watermark ID, public key and digital signature data, as details of which will be described later.

The server 620(3) is, for example, a watermark ID embedding server having the function of the electronic watermark embedding unit 401 shown in FIG. 4 mentioned above, and performs embedding processing of the watermark ID in the image data 501 using the electronic watermark technique.

In the network system 600 described above, the user (signer S) first inputs at the terminal device 630(1) (computer B) the image data 501 (target digital data) from the digital data input device 640.

Next, the signer S requests the watermark ID issuance server 620 (1) on the network 610 to issue the watermark ID (watermark request) corresponding to the image data 501, via a Web browser or the like, by means of the terminal device 630(1).

The watermark ID issuance server 620 (1) issues a watermark ID corresponding to the image data 501 in response to the request from the signer S.

Obtaining the watermark ID from the watermark ID issuance server 620 (1) via the network 610 by means of the terminal device 630(1), the signer S next transmits the image data 501 and the watermark ID via the network 610 to the watermark ID embedding server 620(3), and also requests the watermark ID embedding server 620(3) to embed the watermark ID in the image data 501.

The watermark ID embedding server 620(3) embeds a watermark ID in the image data 501 in response to the request from the signer S, generates the image data (electronic watermark embedded image data) 502 in which the watermark ID is embedded, and transmits this to the terminal device 630(1) via the network 610.

It should be noted that the embedding processing of the watermark ID may not be performed by the watermark ID embedding server 620(3), but for example, the signer S may perform it by means of the terminal device 630(1).

Next, the signer S processes the electronic watermark embedded image data 502 using the secret key in the public key cryptosystem of the signer S by means of the terminal device 630(1), thus generating the digital signature data.

Next, the signer S transmits the watermark ID, the public key in the public key cryptosystem used by the signer S, and the digital signature data to the watermark ID managing server 620(2) via the network 610 by means of the terminal device 630(1).

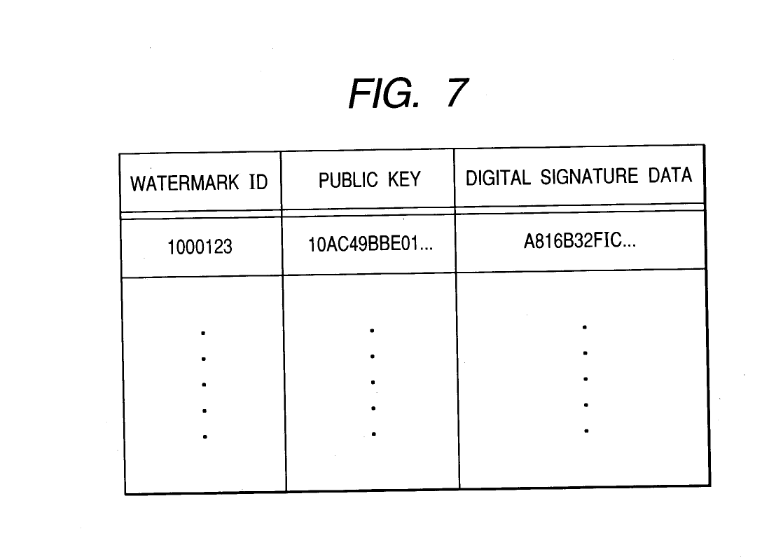

The watermark ID managing server 620(2) registers and manages information transmitted from of the terminal device 630(1), for example, as the reference listing data constituted of watermark ID, the public key and the digital signature data as shown in FIG. 7.

Now, assume that the user (verifier V) has obtained the electronic watermark embedded image data 502 via the network 610 in the terminal device 630(2) (computer A).

The verifier V obtains the public key and digital signature data from the electronic watermark embedded image data 502 by means of the terminal device 630(2).

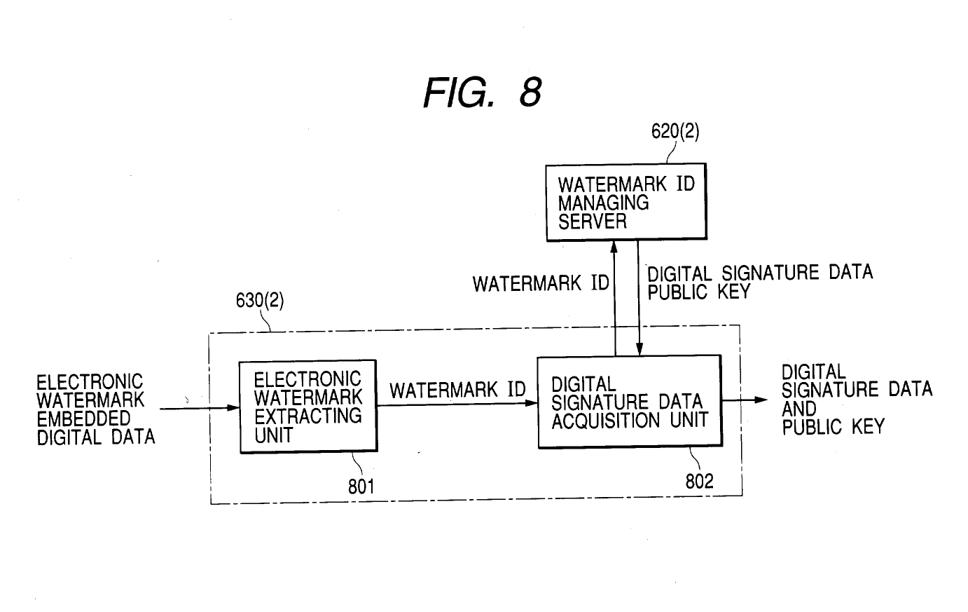

Concretely, for example, the terminal device 630(2) has a digital signature data obtaining function as shown in FIG. 8.

That is, the terminal device 630(2) comprises an electronic watermark extracting unit 801 and a digital signature acquisition unit 802.

In the terminal device 630(2), the electronic watermark embedded image data 502 obtained by the verifier V is first input to the electronic watermark extracting unit 801.

The electronic watermark extracting unit 801 extracts the watermark ID from the electronic watermark embedded image data 502 using a technique corresponding to the electronic watermark technique owned by the watermark ID embedding server 620(3), and inputs this to the digital signature data acquisition unit 802 at a subsequent stage.

The digital signature data acquisition unit 802 makes an inquiry at the watermark ID managing server 620(2) via the network 610 using the watermark ID from the electronic watermark extracting unit 801.

The watermark ID managing server 620(2) searches the reference listing data as shown in FIG. 7 in response to the inquiry from the digital signature data acquisition unit 802 of the terminal device 630(2), and acquires the public key in the public key cryptosystem and digital signature data of the signer S corresponding to the watermark ID in the inquiry, and then transmits the information to the digital signature data acquisition unit 802 of the terminal device 630(2) via the network 610.

Accordingly, the verifier V compares the hash value obtained from the public key and digital signature data that are obtained by the digital signature data acquisition unit 802 with the hash value calculated from the target digital data, by means of the terminal device 630(2), using the function of the digital signature verifying apparatus 200 shown in FIG. 2 mentioned above that the terminal device has, and verifies the originality of the target digital data.

Concretely, for example, if the watermark ID is correctly extracted in accordance with the function of the digital signature verifying apparatus 200 shown in FIG. 2 mentioned above and the hash values each correspond, the terminal device 630(2) determines that the electronic watermark embedded image data 502 is not falsified, and outputs the value of “true”. On the other hand, if the watermark ID is correctly extracted and the hash values each do not correspond, the terminal device 630(2) determines that the electronic watermark embedded image data 502 is falsified, and outputs the value of “false”.

It should be noted that when the watermark ID is not correctly extracted, it may be determined that the image data does not originally have a digital signature or that it has been subjected to some kind of falsification.

As described above, in the network system 600 shown in FIG. 6 mentioned above, the watermark ID issuance server 620(1) and watermark ID managing server 620(2) on the network 610 stores the digital signature data in association with the watermark ID, thereby making it possible to verify whether the target digital data is falsified or not without adding the digital signature data to the target digital data.

It should be noted that the watermark ID issuance server 620(1), watermark ID managing server 620(2) and watermark ID embedding server 620(3) are each configured as independent servers in FIG. 6 mentioned above, but they are not limited to this and one server may be configured to combine these three functions, for example.

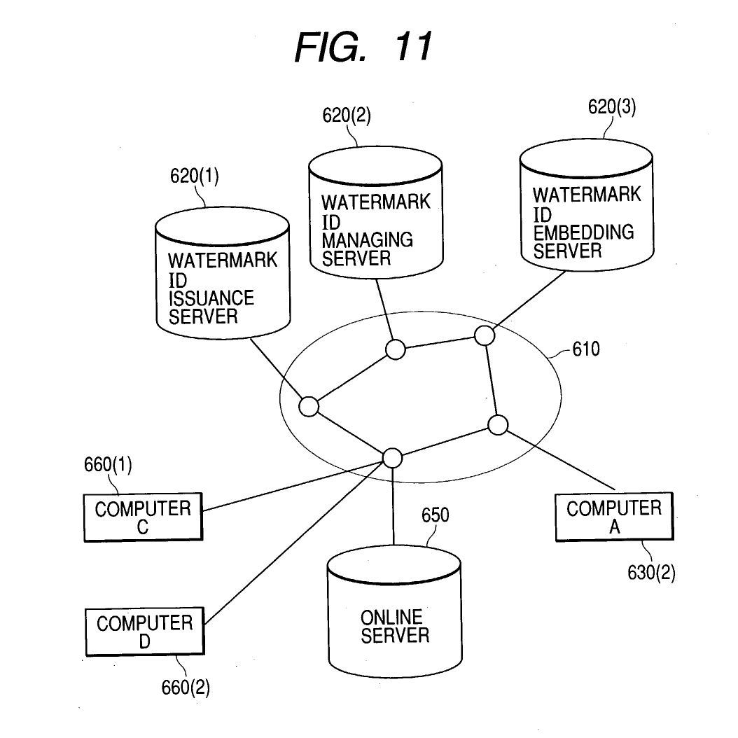

Furthermore, as shown in FIG. 11, the signer S may be an online server 650 for managing the contents uploaded from a terminal device 660(1) (computer C) or a terminal device 660(2) (computer D) by way of the network 610. The contents on the online server may be available for browsing from the terminal device 630(2) (computer A).

As has already been described, the online server 650, which is the signer S, requests the watermark ID issuance server 620(1) to issue the watermark ID, requests the watermark ID embedding server 620(3) to embed the watermark ID, generates digital signatures, and registers the watermark ID, public key and digital signature on the watermark ID managing server 620(2), with respect to each content.

At this point, the digital signature is accomplished using the secret key assigned to the server in the public key cryptosystem of the server.

Furthermore, the online server 650 may serve as all of the signer S, watermark ID issuance server 620(1), watermark ID managing server 620(2) and watermark ID embedding server 620(3).

It should be noted that the contents may be uploaded onto the online server after the request for the issuance of the watermark ID and request for the embedding of the watermark ID have been made at the terminal devices 660(1), (2). In this context, the online server needs to be notified from the terminal devices 660(1), (2) of the watermark ID of the contents targeted for digital signature. Further, after generating the digital signature data, it is necessary to register the digital signature data and the public key of the server on the watermark ID managing server 620(2).

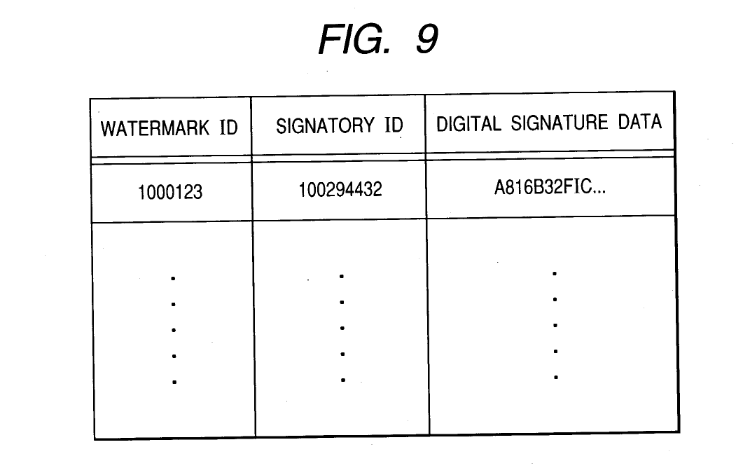

Furthermore, the reference listing data retained by the watermark ID managing server 620(2) is not limited to the data as shown in FIG. 7 above, but as shown in FIG. 9, for example, it may be the data in which the ID of the signer S is registered and retained instead of the public key of the signer S. In this case, it is possible to inquire at the server that manages the public keys in the public key cryptosystem on the basis of the ID of the signer S and to indirectly obtain the public key used by the signer S.

Still further, when the image data 501 has a value as a content, not only the reference listing data as shown in FIG. 7 mentioned above (or FIG. 9) but also copyright information about the image data 501 may be registered and managed in the watermark ID managing server 620(2). In this case, it is possible for the signer S to give a system for checking whether the watermark embedded image data distributed on the network 610 is changed or not in connection with all obtainers of the watermark embedded image data on the network 610.

Further yet, the target digital data is not limited to image data, but moving image data or sound data is also applicable thereto, for example.

<Information Processing Apparatus to Which Digital Signature Generating Apparatus 100 and Digital Signature Verifying Apparatus 200 are Applied>

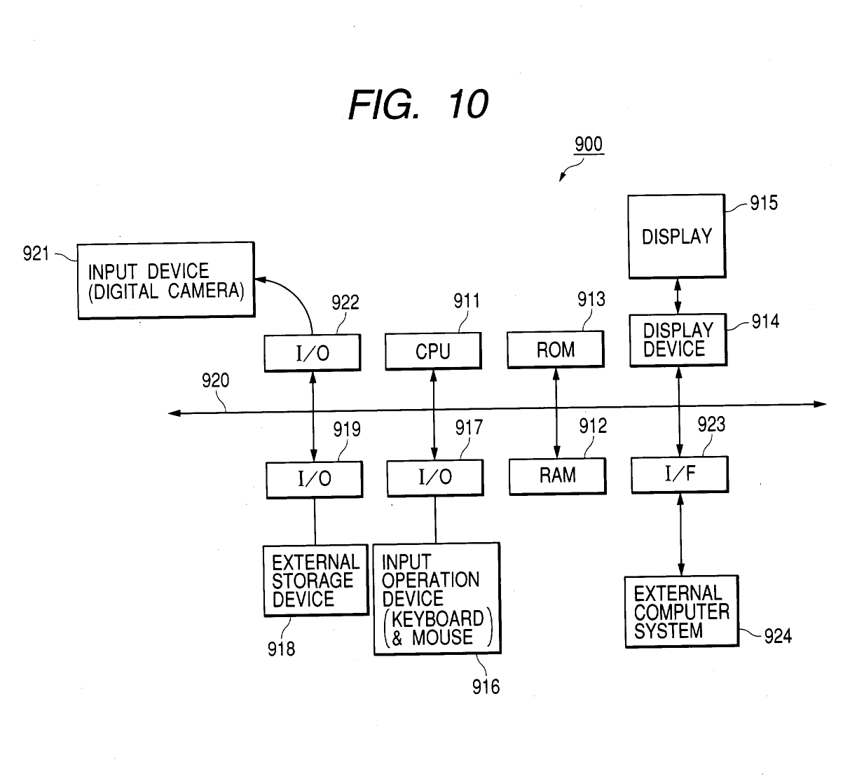

FIG. 10 shows the configuration of an information processing apparatus 900 (computer) for embedding and extracting electronic watermarks and for generating and verifying digital signatures in accordance with the function of the digital signature generating apparatus 100 shown in FIG. 1 mentioned above and the function of the digital signature verifying apparatus 200 shown in FIG. 2 mentioned above.

The information processing apparatus 900 is applied to, for example, the terminal devices 630(1), 630(2) shown in FIG. 6 mentioned above.

In the configuration of the information processing apparatus 900, a CPU 911, a RAM 912, a ROM 913, a display control unit 914 for a display 915, a connection I/O 917 of an input operation device 916 such as a device keyboard or mouse, a connection I/O 919 of an external storage device 918, a connection I/O 922 with an input device 921 such as a digital camera, digital video camera or image scanner, and an interface unit 923 with an external computer system 924 are connected to a bus 920 so as to be able to communicate.

In the information processing apparatus 900, a program that enables the computer to achieve the function of the digital signature generating apparatus 100 shown in FIG. 1 mentioned above and the function of the digital signature verifying apparatus 200 shown in FIG. 2 mentioned above is stored in advance in the ROM 913 or the external storage device 918 so that the computer can read and execute the program.

Accordingly, the CPU 911 executes the program after loading the program onto the RAM 912 from the ROM 913 or after previously loading the program onto the RAM 912 from the external storage device 918, thereby achieving the function of the digital signature generating apparatus 100 shown in FIG. 1 mentioned above and the function of the digital signature verifying apparatus 200 shown in FIG. 2 mentioned above.

It should be noted that the storage location of the program that achieves the function of the digital signature generating apparatus 100 shown in FIG. 1 mentioned above and the function of the digital signature verifying apparatus 200 shown in FIG. 2 mentioned above is not limited to the ROM 913 or external storage device 918, but may be, for example, a device or a system (e.g., the external computer system 924) on the network. In this case, the CPU 911 executes the program after downloading the program to load it onto the RAM 912 by communicating with the storage location of the program via the interface unit 923, thereby performing the function of the digital signature generating apparatus 100 shown in FIG. 1 mentioned above and the function of the digital signature verifying apparatus 200 shown in FIG. 2 mentioned above.

Then, in the information processing apparatus 900, if the digital data targeted for the embedding and extraction of the electronic watermark and for the generation and verification of the digital signature is image data, the image data obtained by the input device 921 such as a digital camera or digital video camera is input to the information processing apparatus 900.

The CPU 911 accumulates the input image data inside the RAM 912 via the connection I/O 922.

It should be noted that the input image data is not limited to the image data obtained by the input device 921, but may be, for example, the image data previously stored in the external storage device 918 or the image data obtained by a device or a system (e.g., the external computer system 924) on the network. In this case, for example, the CPU 911 accumulates the image data of the external storage device 918 inside the RAM 912 via the connection I/O 919, or accumulates the image data of the device or system on the network inside the RAM 912 via the interface unit 923.

Furthermore, for example, in the information processing apparatus 900, if the digital data targeted for the embedding and extraction of the electronic watermark and for the generation and verification of the digital signature is sound data, the sound data obtained by the input device 921 such as a microphone is input to the information processing apparatus 900.

The CPU 911 accumulates the input sound data inside the RAM 912 via the connection I/O 922.

It should be noted that the input sound data is not limited to the sound data obtained by the input device 921, but may be, for example, the sound data previously stored in the external storage device 918 or the sound data obtained by a device or a system (e.g., the external computer system 924) on the network. In this case, for example, the CPU 911 accumulates the sound data of the external storage device 918 inside the RAM 912 via the connection I/O 919, or accumulates the sound data of the device or system on the network inside the RAM 912 via the interface unit 923.

Furthermore, for example, in the information processing apparatus 900, if the digital data targeted for the embedding and extraction of the electronic watermark and for the generation and verification of the digital signature is moving image data, the moving image data obtained by the input device 921 such as a digital camera or digital video camera is input to the information processing apparatus 900.

The CPU 911 accumulates the input moving image data inside the RAM 912 via the connection I/O 922.

It should be noted that the input moving image data is not limited to the moving image data obtained by the input device 921, but may be, for example, the moving image data previously stored in the external storage device 918 or the moving image data obtained by a device or a system (e.g., the external computer system 924) on the network. In this case, the CPU 911 accumulates the moving image data of the external storage device 918 inside the RAM 912 via the connection I/O 919, or accumulates the moving image data of the device or system on the network inside the RAM 912 via the interface unit 923.

It should be noted that the verification of the digital signature is controlled through input from the interface unit 923 (communication means) via the input operation device 916 such as a device keyboard or mouse, a network or the like.

Furthermore, the embedding of the electronic watermark and the generation of the digital signature data may be performed by means of a dedicated hardware circuit or the like inside the input device 921 such as a digital camera or digital video camera immediately after picking up an image. Alternatively, they may be performed by means of a computer function that performs the same function as that of the information processing apparatus 900 immediately after picking up an image.

It should be noted that the present invention is applicable to both a system constituted of a plurality of devices (e.g., host computer, interface device, reader, printer) and an apparatus constituted of one device (e.g., copying machine, facsimile device).

Furthermore, it is needless to mention that the object of the present invention is also achieved in such a way that the system or device is provided with a storage medium that stores the program codes of software which accomplish the functions of the host and terminals in the present embodiment and the computer of the system or device (or CPU or MPU) reads and performs the program code stored in the storage medium.

In this case, the program code read from the storage medium itself achieves the function of the present embodiment, and the storage medium storing the program code and the program code constitute the present invention.

It is possible to use a ROM, a flexible disk, a hard disk, an optical disk, a magnetic optical disk, a CD-ROM, a CD-R, a magnetic tape, a nonvolatile memory card or the like as the storage medium for providing the program code.

Furthermore, it is needless to mention that the function of the present embodiment is achieved by executing the program code read by the computer, but such a case is also included that, in accordance with the instruction of the program code, an OS or the like operating on the computer performs part or all of the actual processing, and by means of which processing the function of the present embodiment is achieved.

Furthermore, it is needless to mention that such a case is also included that after the program code read from the storage medium is written in a memory that an extended function board inserted into the computer or a function extending unit connected to the computer comprises, a CPU or the like that the extended function board or function extending unit comprises performs, in accordance with the instruction of the program code, part or all of the actual processing, and by means of which processing the function of the present embodiment is achieved.

When the present invention is applied to the storage medium, a program code corresponding to the operation described earlier is stored in the storage medium.

As described above, in the present invention, the transmitting end generates the digital signature data for the digital data, and registers the digital signature data and identification information, which is appended to the target digital data, on a data managing end on the network so as to manage them. Further, the receiving end is configured to obtain a corresponding digital signature from the data managing end on the network in accordance with the identification information appended to the digital data by means of an electronic watermark technique or the like and to verify the originality of the digital data.

It is thus possible to eliminate the need to store the digital signature data inside the digital data.

What is claimed is:

1. An information processing apparatus connectable to a network comprising:
signature data generating means for generating signature data of data;
acquiring means for acquiring identification information for uniquely identifying said data; and
output means for outputting said signature data and said identification information onto said network.

2. An apparatus according to claim 1, further comprising:
adding means for adding said identification information to said data; and
distributing means for distributing the data to which said identification information is added via said network.

3. An apparatus according to claim 1, wherein said signature data generating means calculates said data by means of a hash function to obtain a hash value, and encrypts said obtained hash value using a key in a public key cryptosystem, thereby generating said signature data.

4. An apparatus according to claim 1, wherein said identification information is issued by an external device on said network.

5. An information processing apparatus connectable to a network comprising:
receiving means for receiving data via said network;
extracting means for extracting identification information for uniquely identifying said data from said data;
transmitting means for transmitting said identification information to a data managing device on said network;
signature data acquiring means for acquiring signature data corresponding to said data from said data managing device; and
verifying means for verifying said data using said signature data.

6. An apparatus according to claim 5, wherein said extracting means extracts the identification information added to said data using an electronic watermark technique.

7. An apparatus according to claim 5, wherein said signature data acquiring means acquires a public key in a public key cryptosystem together with said signature data from said data managing device; and
said verifying means verifies the originality of said data by comparing a value obtained by decrypting said signature data by means of said acquired public key, with a value obtained by applying predetermined calculation to said data.

8. An information processing apparatus connectable to a network comprising:
first receiving means for receiving identification information intended to uniquely identify data and signature data of said data from a first external information processing apparatus via said network;
managing means for managing said identification information and said signature data in a manner that they correspond;
second receiving means for receiving said identification information from a second external information processing apparatus via said network; and
transmitting means for transmitting signature data managed by said managing means and corresponding to said identification information to said second external information processing apparatus,
wherein said identification information is added to said data to be distributed from said first external information processing apparatus to said second external information processing apparatus via said network.

9. An information processing method comprising the steps of:
generating signature data of data;
acquiring identification information for uniquely identifying said data; and
outputting said signature data and said identification information onto said network.

10. An information processing method comprising the steps of:
receiving data via a network;
extracting identification information for uniquely identifying said data from said data;
transmitting said identification information to a data managing device on said network;
acquiring signature data corresponding to said data from said data managing device; and
verifying said data using said signature data.

11. An information processing method comprising the steps of:
receiving identification information intended to uniquely identify data and signature data of said data from a first external information processing apparatus via said network;
managing said identification information and said signature data in a manner that they correspond;
receiving said identification information from a second external information processing apparatus via said network; and
transmitting signature data corresponding to said identification information to said second external information processing apparatus,
wherein said identification information is added to said data to be distributed from said first external information processing apparatus to said second external information processing apparatus via said network.

12. A program for a computer to implement an information processing method comprising the steps of:
generating signature data of data;
acquiring identification information for uniquely identifying said data; and
outputting said signature data and said identification information onto a network.

13. A program for a computer to implement an information processing method comprising the steps of:
receiving data via a network;
extracting identification information for uniquely identifying said data from said data;
transmitting said identification information to a data managing device on said network;
acquiring signature data corresponding to said data from said data managing device; and
verifying said data using said signature data.

14. A program for a computer to implement an information processing method comprising the steps of:
receiving identification information intended to uniquely identify data and signature data of said data from a first external information processing apparatus via said network;
managing said identification information and said signature data in a manner that they correspond;
receiving said identification information from a second external information processing apparatus via said network; and
transmitting signature data corresponding to said identification information to said second external information processing apparatus,
wherein said identification information is added to said data to be distributed from said first external information processing apparatus to said second external information processing apparatus via said network.

15. A storage medium storing in a computer-readable manner a program for a computer to implement an information processing method comprising the steps of:
generating signature data of data;
acquiring identification information for uniquely identifying said data; and
outputting said signature data and said identification information onto a network.

16. A storage medium storing in a computer-readable manner a program for a computer to implement an information processing method comprising the steps of:
receiving data via a network;
extracting identification information for uniquely identifying said data from said data;
transmitting said identification information to a data managing device on said network;
acquiring signature data corresponding to said data from said data managing device; and
verifying said data using said signature data.

17. A storage medium storing in a computer-readable manner a program for a computer to implement an information processing method comprising the steps of:
receiving identification information intended to uniquely identify data and signature data of said data from a first external information processing apparatus via said network;
managing said identification information and said signature data in a manner that they correspond;
receiving said identification information from a second external information processing apparatus via said network; and
transmitting signature data corresponding to said identification information to said second external information processing apparatus,
wherein said identification information is added to said data to be distributed from said first external information processing apparatus to said second external information processing apparatus via said network.
